(19) United States
(12) Patent Application Publication
(10) Pub. No.: US 2005/0076082 A1
(43) Pub. Date: Apr. 7, 2005

(54) Method and system for managing the exchange of files attached to electronic mails

(76) Inventors: Jean-Francois Le Pennec, Nice (FR); Aurelien Bruno, Nice (FR)

Correspondence Address: AT&T CORP., P.O. BOX 4110, MIDDLETOWN, NJ, 07748, US

(21) Appl. No.: 10/638,861

(22) Filed: Aug. 11, 2003

(30) Foreign Application Priority Data
Nov. 27, 2002 (FR) 0214868

(51) Int. Cl. G06F 15/16

(52) U.S. Cl. 709/206

(57) ABSTRACT

Method of managing the exchange of a file from a sender (13) to a receiver (12, 15) in a data transmission network (10, 11) wherein any user amongst a plurality of users can send an electronic mail with at least an attached file to at least another user. The method comprises the following steps:
the original file corresponding to the file to be sent as an attachment to the electronic mail is forwarded by the sender to a file server (14), a substitute file including at least data identifying the original file is sent by the file server back to the sender upon receiving the original file, the substitute file is attached to the electronic mail before sending this one by the sender to the receiver, and the receiver gets, at anytime, the original file from the file server by providing the file server with the parameters of the substitute file.

### TECHNICAL FIELD

The present invention relates generally to data transmission networks, such as the Internet network, wherein it is not easy to transmit files attached to electronic mails because these files are too large or their transmission is restricted to registered users, and relates in particular to a method and a system for managing the exchange of files attached to electronic mails.

### BACKGROUND

In the Electronic communication world of today, the major tool used everyday by several hundreds of million people is the Electronic mail (email). With this tool, people send and receive basic messages with text inside but also messages more sophisticated by attaching electronic files to the messages.

The types of attached files are numerous and unlimited. The most known file types are document (Microsoft Word, Adobe Acrobat), presentation (Microsoft PowerPoint), Audio and Video Files. The attached files can also represent an application or executable file if the mail system has no security restriction on this file type, which is often the case on professional email servers.

Further to the fact that hackers are using this attachment capability to distribute viruses, the attachment has other drawbacks. One important drawback is due to the size of some attachments that is not compatible with email servers. In order to avoid mail system congestion, there is very often a limitation on the file size that can be attached. In addition, a large file may disturb both the transmitter and the receiver.

The quantity of files with respect to the mailbox size is also a limitation of email systems. Not all receivers want to receive large attachments that overload the mailbox and take too much time when the link is not fast, such as remote access. After that, the receivers have to download it from their mail to their hard drive and then, to remove it from their mail (if not, their mailbox will crash rapidly). By following these steps, the receivers loose the link between the mail and the file and then do not always remember the name of the file and where it has been stored. Furthermore, the files are not always compressed, which leads to an increased traffic on the network and storage problems in mail servers and workstations.

File attachments are also used in workrooms, secured web-based servers (HTTP, FTP) or Peer-to-Peer file sharing, which are all restricted to registered users. When these users get access, they have access to all documents within this workroom or database. So, those systems have to be managed and the users have to remember passwords as well as connections to these workrooms, URLs or Peer-to-Peer servers. Manually, a user can build an FTP or HTTP server or Peer-to-Peer connection, send an email with enough information for another user to use an FTP client, a browser or Peer-to-Peer software to download the file with the corresponding parameters. However, this takes time for both the sender and the receiver to perform all the tasks and requires both skill and relevant software. The main task is, however, for the sender who has to administer the server or request someone to do it, that is to put the authorizations on the file or directory, define accounts for receivers or offer full access to all files, which is not very secure even on the intranet network.

If the user allows FTP on his PC, then it is more difficult to allow access to only this specific file and not the others stored there, because FTP is based on server access and not on file access. The authorization management becomes a nightmare if the user has to manage them. If another user needs the file, the file owner has to contact again an administrator to add him/her as a user. Following this process, the users have to be members of so many workrooms that they do not know on which to find the information.

Today, web servers with URL links are commonly used. As users, the people are using them to get files but not all people are able to build URLs and put the files on the servers. This loading and configuration are not easy and furthermore need some administration authorizations. Some servers have free access and some other ones need user authentication even for read access, which needs some additional mechanism.

Another point is the inter-company file sharing. If the file is for a user not belonging to the same company, then the limitations for both companies are reached and it is difficult to find a shared common site to transmit a large file.

From the above, it is clear that the exchange of files attached to emails between users raises more and more problems insofar as either the files are large and overload the user mailbox and/or take too much time to be transmitted to the user and, subsequently, this usage is a kind of denial of service of email, or the files are not transmitted because of security or size limitation rules. Other existing file exchange solutions (web servers or workrooms) have their own drawbacks as listed above, especially in administration and security area.

### SUMMARY OF THE INVENTION

Accordingly, the main object of the invention is to achieve a method and to provide a system for managing the exchange of files attached to emails, such method and system bypassing the file attachment limitation by using a simple mechanism attached to the email instead of the file itself and adapted to allow the user to retrieve the file later.

The invention relates therefore to a method of managing the exchange of a file from a sender to a receiver in a data transmission network wherein any user amongst a plurality of users can send an electronic mail with at least an attached file to at least another user. The method comprises the following steps:
the original file corresponding to the file to be sent as an attachment to the electronic mail is forwarded by the sender to a file server,
a substitute file including at least data identifying the original file is sent by the file server back to the sender upon receiving the original file,
the substitute file is attached to the electronic mail before sending this one by the sender to the receiver, and
the receiver gets, at anytime, the original file from the file server by providing the file server with the parameters of the substitute file.

According to another aspect, the invention relates to a system for managing the exchange of a file from a sender to a receiver in a data transmission network wherein any user amongst a plurality of users can send an electronic mail with at least a file attached thereto to at least another user. The system comprises a file server adapted to build a substitute file when receiving from the sender an original file corresponding to the file to be attached to the electronic mail, such a substitute file including data identifying the original file enabling the receiver which receives the substitute file attached to the electronic mail from the sender to get the original file by forwarding the parameters of the substitute file to the file server.

### BRIEF DESCRIPTION OF THE DRAWINGS

The above and other objects, features and advantages of the invention will be better understood by reading the following more particular description of the invention in conjunction with the accompanying drawings wherein:

FIG. 1 is a block-diagram representing an electronic mail environment wherein the method according to the invention can be achieved;

FIG. 2 is a diagram representing the flows between a sender and the file server for storing the original file and getting the substitute file;

FIG. 3 is a diagram representing the flows used by a receiver to get an original file from the file server;

FIG. 4 is a block-diagram representing the different functions used to put the original file in the file server or to get the original file from the file server;

FIG. 5 is a diagram representing the registration flows used between the user and the file server; and

FIG. 6 represents the structure of the substitute file attached to the email forwarded by the sender to the receiver.

### DETAILED DESCRIPTION OF THE INVENTION

FIG. 1 describes a networking environment including the Internet network 10 and an Intranet network 11 wherein three workstations 12, 13 and 15 have the capability to exchange data files thanks to a mail server (MS) 17. For example, workstation 13 is a sender (SND) and workstations 12 and 15 are receivers (RCV1 and RCV2). It is assumed that sender 13 does not have not the capability to transmit a file directly as an email attachment to receiver 12 or 15, either because of its size or because of security rules such as rules preventing executable files to be sent or received. In addition, SND 13 does not want, does not have not the capability or is not allowed to act as a server (such as an FTP server) itself so that direct file exchange without email is not feasible.

According to the invention, the original file to be exchanged is first stored by sender 13 in a file server, either FS1 16 connected to the Internet network 10 or FS2 14 connected to the Intranet network 11. The need for several file servers is for redundancy and also to limit the access by users to some networks only. Thus, it can be assumed that RCV1 15 can only access FS1 16 and RCV2 12 can only access FS2 14.

Instead of the original file, a substitute file is then attached to the email transmitted by SND 13. The substitute file can be an executable file such as a JavaBeans (trademark of SUN) component or ActiveX (trademark of Microsoft) file that will include both the executable software to perform the download and the substitute text file including all parameters and information related to the original file. An alternative is to send just the substitute text file, as described later, without the executable software for users that already have it installed on their workstation, or to bypass firewall issues blocking executable files. The executable code which provides the access to the file server can be downloaded from the file server itself via a web server or provided in an email during the registration phase as described later. This software download is required only once.

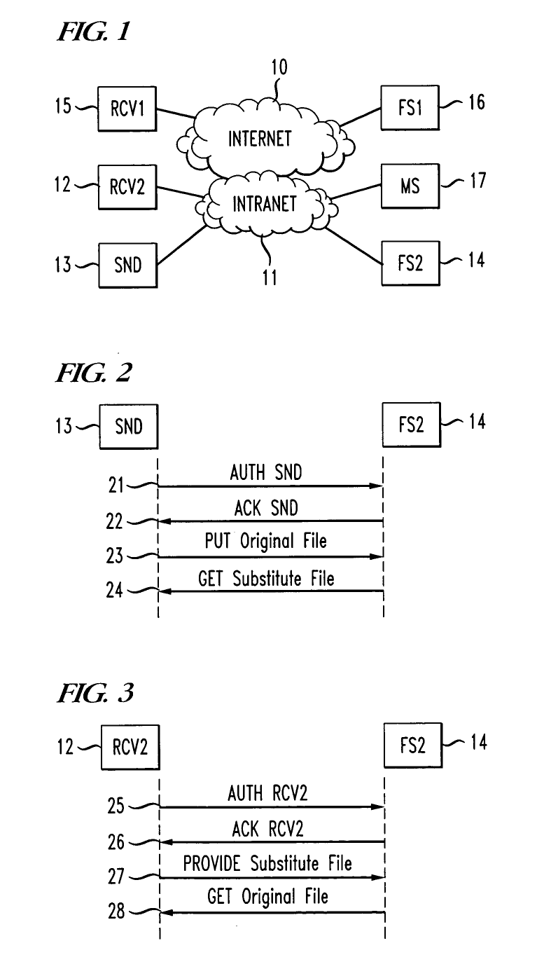

The process to store a file from a workstation such as SND 13 into a file server such as FS2 14 is shown in FIG. 2. It starts by step 21 AUTH SND of authentication of the sender which can be achieved by using authentication keys, based on a public key known by the file server. If the user does not have predefined authentication keys such as a user certificate, the file server can provide such keys thanks to a secure process based on emails. Once authentication is made, the file server answers with an ACK SND message 22.

Then, the sender can send the file to the file server using FTP or HTTP Protocol referred as step “PUT original file” 23. When processed by the file processing software in the workstation, the original file may be encrypted and/or compressed using keys provided by the file server, though this pre-processing can be done at any time before this step.

When the original file is received by the file server, this one computes a unique file identification and builds a substitute file sent back to the sender at step GET substitute file 24. This step can be a simple file transfer using FTP or HTTP, but a preferred method may be to send the substitute file by email to the user inasmuch as some firewalls could prevent the first solution from being run. It must be noted that the substitute file can also be built in the workstation, but the ID of the file which is unique within the file server and the way to retrieve the original file have to be provided by the file server.

When the user of workstation SND 13 wants to provide the file to users of RCV1 15 or RCV2 12 as an example, he has just to add this substitute file as an attachment in the email sent to RCV1 and RCV2. An option is to copy the file server to the email so that it knows which users are allowed to get the file depending on the security rules applied to this file and which are detailed in some fields of the substitute file.

With or without the executable part, the substitute file allows email receivers to retrieve the original file. The email receiver opens, for example, an ActiveX/JavaBeans included in the mail (which replaces the original file) and this allows him to automatically retrieve (download) the attachment from the mail attachment server using FTP or HTTP if no security means were required at the creation steps.

Generally, a more secure mechanism is required. As illustrated in the process flows of FIG. 3, the process starts with a receiver (here RCV2 12) authentication process similar to FIG. 2 involving steps 25 and 26. In fact, as users may both send and receive files, they just need a single registration means for both which can be used previously as explained below.

Only the file corresponding to the attachment, and specifically to the file ID field, can be retrieved from the file server. All information such as server address, file name, and authentication parameters are included in the substitute file and processed transparently. Step 27 “PROVIDE Substitute File” corresponds to a message sent by the RCV2 user to FS2 file server to get the substitute file. This can be managed by the same piece of software used to store the file which is either preloaded in the workstation or included in the substitute attachment or can be downloaded from any file server thanks to a web browser. The original file is retrieved using FTP or HTTP protocol started by the user at step 28 of “GET Original File”.

It must be noted that, if another user such as RCV1 15 can only reach file server 16 connected to the Internet network 10, and if file server FS1 16 does not have the requested file, it can get it from file server FS2 14 provided that the file servers have secure means to communicate with each other.

Note that the retrieve mechanism manages the authentication to the file server, which is unique for a file, and once the authentication is done, the second verification uses the file hash value, also included in the substitute file. Therefore, a scanning attack of all possible combinations may only grant the access to the step where the hash value is requested. Only the substitute file will contain this hash value, which is difficult to hack. Servers for such files may be completely access-free even for people storing files, especially on the intranet.

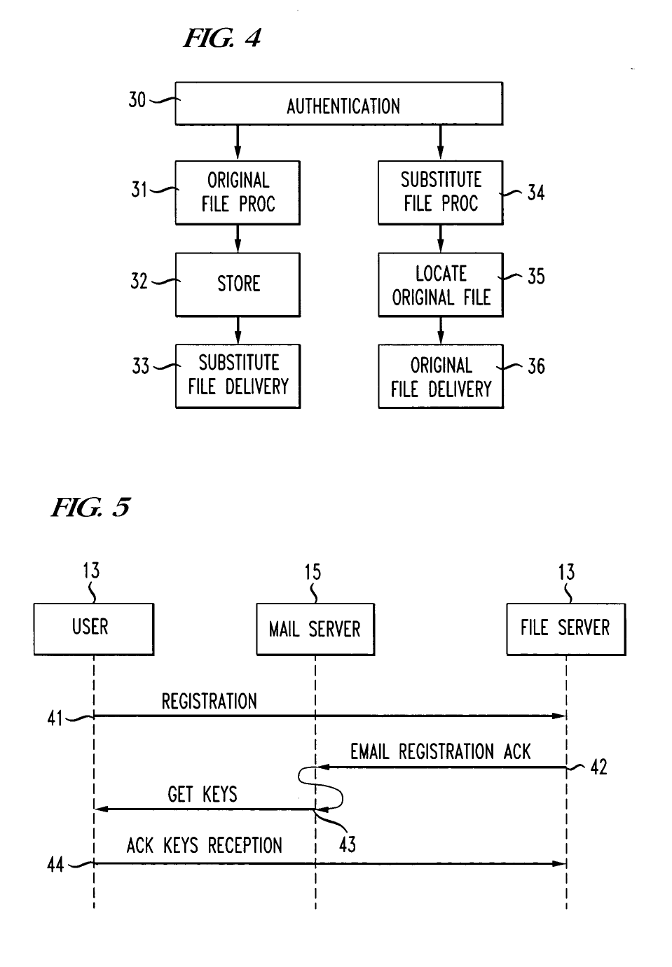

Now, FIG. 4 describes the functions included in the software used to interface the file server. The first main building block is the authentication function 30 that is used to authenticate the user. This authentication function uses a private key and its associated public key that is stored by the operating system in a file. It also can reach a file containing the address of known file servers such as the HOST file. During the authentication phase, messages are hashed/signed using the sender private key and the receiver uses the corresponding public key to authenticate the signature.

Once the authentication is performed, a choice between two procedures is allowed: the storing file procedure or the retrieving file procedure. For storing files, the procedure “Original File Proc” 31 allows preparation of the file for storage, such as hashing the file to get a signature, compressing, and encrypting if needed. The server public key is also used to encrypt the file that is sent so that a transmission over an insecure network (Internet) is fully protected: authentication for server connection, file hashing verification and then file encryption for download are possible options.

A secure file-by-file storage and a retrieval process are built that do not need any password. The risk, even with a server located on the Internet, is very limited because it is a file-by-file access mechanism with a dual security level. Each file has a different authentication access and a different hash value (two verification steps) and only the port number corresponding to this protocol needs to be open since there is no need to open legacy HTTP or no FTP ports.

The proposed solution uses no password, but just the substitute file ID once and a downloadable private key per user as described below. Then, the password cannot be lost. User private keys and associated public keys may be changed at any time. A server public key change may be done by the server through an email with validation using the current key in normal cases (previous key not compromised).

Then, the file may be downloaded to the server using a legacy file transfer protocol by the function Store 32. During this phase, the user may define specific parameters to apply to the storage, such as time to keep the file, access protection and storage protection or virus-free verification. The software, then, waits for the file processing on the server side which should terminate by an acknowledge message of the storage and the transmission by the file server of the substitute file confirming the requested parameters. The reception and storage of the substitute file with optional email software interface corresponds to functional block “Substitute File Delivery” 33.

For retrieving files, the substitute file procedure “Substitute File Proc” 34 analyses the received substitute file and shows the parameters to the user on its user interface. The user interface in the proposed embodiment is a web browser. Based on the information and on existing parameters on the workstation, the user can then proceed directly to locate the file or may have to register again if the domain to which the server belongs is not one of the registered domains of the workstation. The “Locate Original File” function 35 allows identifying the closest server from which the file may be downloaded. Based on the current IP address, the main server given in the substitute file may give an alternate server name to optimize the download or, if the main server cannot be reached, the home server of the workstation will have to solve this best location identification or even get the file itself from the main server. The last function 36 is the download or “Original File Delivery” which uses a legacy file transfer protocol to get the file.

Different levels of security may be achieved by the file storage, but a preliminary step is to authenticate the users. The use of user certificates stored in workstations or in removable devices is something possible within a company. In that case, such certificates may be re-used and this removes the need for user authentication done at the server level because the server will be able to validate user certificates directly with the company Certificate Authority (CA). Otherwise, a dedicated mechanism can be used as illustrated in FIG. 5.

This authentication is not always required if no protection is needed corresponding to free public file storage. Instead, people storing files or retrieving files may get a key and an ID the first time they store or get something.

In the proposed authentication mechanism, there is no password needed as no administrative rights are given on the file server. The file is stored with a predefined mechanism, the security is at the file level and no special skill is required as this solution is managemen-free.

The identity verification of the receiver can be performed if required:
If not, the substitute file will allow the receiver to take directly the original file.
If there is a receiver authentication needed, the receiver will first have a key and ID assigned the first time he will ask for a file on a server. A receiving user will just have to give his mail ID to get the key and ID through an email. This authenticates the user but no password is required. Having this key, a user can both get protected files and put files as well on the server.

The proposed optional registration mechanism is based on email validation. The request for registration is started by the user 13 with a registration message 41 sent to the file server 14, the user providing its email address as a parameter. It can be done in web browser mode on the file server acting as a web server or via email.

The file server answers with an email registration acknowledge mail 42 sent to the mail server 15 on which the user can retrieve and read the mail. This mail 42 in the preferred embodiment contains the user private and public keys and the server public key as well as the user software to install these keys if allowed. These keys may also just be provided as text or as attachment. The user software will get these keys at step 43 and install them in the right files on the operating system so that he can re-use them later. Finally, the user answers with a message 44 that the keys have been received, this message being an email or a direct message in web browser mode used to send the registration (or both for more security).

As described above, the substitute file in its text version contains several fields of data. This file in the preferred embodiment is structured using XML language in order to simplify its visualization by a web browser.

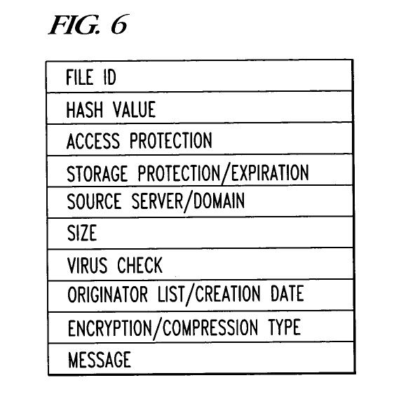

As shown in FIG. 6, the main fields of the substitute file are:
The file ID which is unique in the server or in the domain that may include several servers. This ID is given when the original file is stored in the file server and is the main pointer to the original file simplifying its retrieval.
The hash value computed from the original file which is also normally unique (but not mandatory). It is used as a security validation so that a file cannot be retrieved only by its ID, and a request to the user is used subsequently to provide this hash value corresponding to the file signature in order to be allowed to get it. In addition, it may be used by the server to identify possible duplicated files and therefore, if it is the case, to only keep one file with several pointers to the original files added on the substitute file.
The access protection field which defines the rules to follow for getting the original file. A file may only be retrieved by users listed in the distribution list of the email sent with the substitute file. In that case, a forward of the substitute file to further users is useless as they will not be able to get the file. Even more, a requirement to encrypt the file using the receiver public key may be defined so that the file cannot be intercepted by someone else. Also, the visualization of the file may be linked with viewers or editors to this encrypted file so that the file will never be stored in clear. Other values of the field may correspond to free, internal redistribution allowed (email with same suffix xxx.com) or controlled redistribution (requires adding the file server in copy when the substitute file is forwarded).
The storage protection defining on how many servers the original file should be kept. An additional field defines an expiration date determining the period of time during which the original file is stored in the file server. The file removal may be automatic or granted by the originator.
A source server and domain field indicating the main server storing the original file, the other sources for the file corresponding to alternate servers, and the addresses of these servers where the file can be accessed even if a user makes a request on a server not being a source for the file.
The file size also used to inform the user and for file management (with the hash value).
The virus check option informing the receiver that a virus checking has been performed on the original file (requested by the originator). It indicates which anti-virus software, and at which level, has been used.
The file originator field identifying the user(s) who stored the original file. It may be a list if the same file was stored by several people. An associated field is the creation date of the substitute file.
Encryption and compression parameters which may also be provided as optional. An original file may be stored using one encryption and/or compression technique and may be retrieved using other techniques upon retriever choice. For example, a file may be stored in zip mode with a password and retrieved with RAR compression and SSL encryption between the user and the server.
A message field which may contain any useful information for the user such as an original file content description. It may be very useful for searching as the file cannot be directly scanned. This may include automatically the first sentences of a document, for example.

Note that the substitute file naming can be based on the original file name with a new file extension added or replacing the existing file type. Thus, for an original file called filename.ext, the substitute file can be called filename.ext.sub or filename.sub. In the latter case, the file type can be included in the message field or in an additional dedicated field. This can also be done for the filename if the filename is different for the original file and the substitute file.

While this invention has been described in a preferred embodiment, other embodiments and variations can be effected by a person of ordinary skill in the art without departing from the scope of the invention.

1-19. Cancel

20. A method of managing the transmission of a file in a data transmission network from a sender to a receiver, the method comprising the following steps:
forwarding to a file server an original file to be sent as an attachment to an electronic mail message;
sending a substitute file from the file server to the sender upon receiving the original file at the file server, the substitute file comprising data identifying the file forwarded to the file server;
attaching the substitute file to the electronic mail message to be sent by the sender to the receiver; and
accessing the original file after sending one or more parameters contained within the substitute file to the file server.

21. The method according to claim 20, further comprising the step of including within the substitute file, a hash value computed from the original file, the hash value being used as a file signature so as to access the original file from the file server.

22. The method according to claim 21, further comprising the step of sending to the sender, a distribution list of the users authorized to access the original file.

23. The method according to claim 3, further comprising the step of sending the sender an expiration date which defines a period of time during which the original file will be stored in the file server.

24. The method according to claim 23, further comprising the step of including within the substitute file, the address of one or more file servers containing the original file which are accessible by the receiver.

25. The method according to claim 24, further comprising the step of encrypting the original file before sending the original file to the file server.

26. The method according to claim 24, further comprising the step of compressing the original file before sending the original file to the file server.

27. The method according to claim 21, further comprising the step of authenticating the sender before accepting the original file at the file server.

28. The method according to claim 27, further comprising the step of authenticating the receiver before accessing the original file.

29. The method according to claim 25, further comprising the steps of of registering the sender and then sending the sender a private key and a public key to be used in accessing the original file stored in the file server.

30. The method according to claim 20, further comprising the step of sending the receiver, executable code for accessing the original file.

31. The method according to claim 20, wherein said substitute file is an executable file.

32. A system for managing the transmission of a file in a data transmission network from a sender to a receiver comprising:
a file server operative for creating a substitute file from an original file sent to the file server, the substitute file including data identifying the original file and enabling the receiver to access the original file stored in the file server; and
a workstation in communication with the file server for transmitting an electronic mail message containing the substitute file, the substitute file comprising parameters for allowing the receiver to access the file server.

33. The system according to claim 32, wherein the substitute file includes a hash value computed from the original file, the hash value being operative as a file signature in combination with the identifying data to allow the receiver to access the original file.

34. The system according to claim 33, wherein the server has a distribution list of the users authorized to gain access to the original file, the distribution list being sent to the sender with the substitute file.

35. The system according to claim 34, wherein the file server is operative for storing an expiration date defining a period of time during which the original file is stored on the file server, the expiration date being sent back to the sender with the substitute file.

36. The system according to claim 35, further comprising an alternate file server accessible by the receiver for accessing the original file, the substitute file including the address of the file server or the alternate file server.

37. The system according to claim 36, wherein the file server or the alternate file server is operative for registering the sender before the sender forwards the original file to the file server or alternate file server, the file server or alternate file being operative for accepting an email address as a registration parameter, and for sending the sender a private key and a public key for use in accessing the original file.

38. The system according to claim 37, wherein the file server or alternate file server is operative for downloading executable code to the receiver for accessing the original file.

39. The system according to claim 38, wherein said substitute file is an executable file.
